(19) United States
(12) Patent Application Publication
(10) Pub. No.: US 2017/0079872 A1
(43) Pub. Date: Mar. 23, 2017

(54) ADJUSTABLE SEAT ASSEMBLY

(71) Applicants: Winsen C. Zouzal, Detroit, MI (US); Lear Corporation, Southfield, MI (US)

(72) Inventors: Gerald PATRICK, Shelby Township, MI (US); Winsen C. ZOUZAL, Detroit, MI (US); Kim KRULEK, Wyoming, MI (US); Samuel R. HANLON, Livonia, MI (US)

(21) Appl. No.: 14/861,128

(22) Filed: Sep. 22, 2015

(51) Int. Cl. A61H 9/00; B60N 2/44

(52) U.S. Cl. CPC A61H 9/0078; B60N 2/4415; B60N 2/448; A61H 2205/081

(57) ABSTRACT

A seat air bladder assembly includes a pair of lateral air bladder regions spaced apart laterally, each inclined laterally outboard to stimulate a seat occupant thoracic region. A method for adjusting a seat assembly inflates a first air bladder assembly oriented in a thoracic region of a seat assembly. A second air bladder assembly is oriented in the thoracic region spaced laterally apart from the first air bladder assembly, and is inflated after initiating inflation of the first air bladder assembly. Another method inflates first and second air bladder assemblies oriented spaced apart in an upright direction in a thoracic region of a seat assembly, and a third air bladder assembly oriented therebetween. The second air bladder assembly is inflated after initiating inflation of the first air bladder assembly. The inflation of the third air bladder assembly is concurrent with the first air bladder assembly.

### TECHNICAL FIELD

Various embodiments relate to adjustable seat assemblies.

### BACKGROUND

An adjustable seat assembly is illustrated and described in U.S. Pat. No. 5,758,924, which issued on Jun. 2, 1998 to Lear Corporation.

### SUMMARY

According to at least one embodiment, an air bladder assembly for a seat is provided with at least one pair of lateral air bladder regions spaced apart laterally. Each of the pair of lateral air bladder regions are inclined laterally outboard to stimulate a thoracic region of a seat occupant.

According to at least another embodiment, a seat assembly is provided with a seat back. An air bladder assembly is oriented within a thoracic region of the seat back. The air bladder assembly is provided with at least one pair of lateral air bladder regions spaced apart laterally. Each of the pair of lateral air bladder regions are inclined laterally outboard to stimulate a thoracic region of a seat occupant.

According to at least another embodiment, a method for adjusting a seat assembly is provided with a step of operating an inflation device to inflate a first air bladder assembly oriented in a thoracic region of a seat back of a seat assembly. The inflation device is operated to inflate a second air bladder assembly that is oriented in the thoracic region of the seat back, spaced laterally apart from the first air bladder assembly, after initiating inflation of the first air bladder assembly.

According to at least another embodiment, a computer-program product is embodied in a non-transitory computer readable medium that is programmed for automatically adjusting a seat assembly. The computer-program product is provided with instructions for performing a method for adjusting a seat assembly with a step of operating an inflation device to inflate a first air bladder assembly oriented in a thoracic region of a seat back of a seat assembly. The inflation device is operated to inflate a second air bladder assembly that is oriented in the thoracic region of the seat back, spaced laterally apart from the first air bladder assembly, after initiating inflation of the first air bladder assembly.

According to at least another embodiment, a seat assembly is provided with a seat back. A first air bladder assembly is oriented in a thoracic region of the seat back. A second air bladder assembly is oriented in the thoracic region of the seat back, spaced apart from the first air bladder assembly. An inflation device is in fluid communication with the first and second inflatable air bladder assemblies. A controller is in electrical communication with the inflation device and configured to perform a method for adjusting a seat assembly that is provided with a step of operating the inflation device to inflate the first air bladder assembly. The inflation device is operated to inflate the second air bladder assembly, after initiating inflation of the first air bladder assembly.

According to at least another embodiment, a method for adjusting a seat assembly is provided with a step of operating an inflation device to inflate a first air bladder assembly oriented in a thoracic region of a seat back of a seat assembly. The inflation device is operated to inflate a second air bladder assembly that is oriented in the thoracic region of the seat back, spaced apart from the first air bladder assembly in an upright direction of the seat back, after initiating inflation of the first air bladder assembly. The inflation device is operated to inflate a third air bladder assembly that is oriented in the thoracic region of the seat back in between the first and second air bladder assemblies, concurrently with the inflation of the first air bladder assembly.

According to at least another embodiment, a computer-program product is embodied in a non-transitory computer readable medium that is programmed for automatically adjusting a seat assembly. The computer-program product is provided with instructions for performing a method for adjusting a seat assembly with a step of operating an inflation device to inflate a first air bladder assembly oriented in a thoracic region of a seat back of a seat assembly. The inflation device is operated to inflate a second air bladder assembly that is oriented in the thoracic region of the seat back, spaced apart from the first air bladder assembly in an upright direction of the seat back, after initiating inflation of the first air bladder assembly. The inflation device is operated to inflate a third air bladder assembly that is oriented in the thoracic region of the seat back in between the first and second air bladder assemblies, concurrently with the inflation of the first air bladder assembly.

According to at least another embodiment, a seat assembly is provided with a seat back. A first air bladder assembly is oriented in a thoracic region of the seat back. A second air bladder assembly is oriented in the thoracic region of the seat back, spaced apart from the first air bladder assembly. A third air bladder assembly is oriented in a thoracic region of the seat back in between the first air bladder assembly and the second air bladder assembly. An inflation device is in fluid communication with the first, second and third inflatable air bladder assemblies. A controller is in electrical communication with the inflation device and configured to perform a method for adjusting a seat assembly that is provided with a step of operating an inflation device to inflate the first air bladder assembly. The inflation device is operated to inflate the second air bladder assembly, after initiating inflation of the first air bladder assembly. The inflation device is operated to inflate the third air bladder assembly concurrently with the inflation of the first air bladder assembly.

### BRIEF DESCRIPTION OF THE DRAWINGS

FIG. 1 is a front perspective view of a vehicle seat assembly, illustrated partially disassembled, according to an embodiment; and

FIG. 2 is a rear schematic view of air bladder assemblies of the seat assembly of FIG. 1, illustrated with a skeletal schematic of an occupant.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It is believed that supporting the thoracic region of the spine can reduce forces and support as much as one-third of the upper body mass. By increasing support of the upper body mass, loads are reduced on the muscles, vertebrae, and discs through the spine and pelvic regions. Decreased load reduces fatigue on these areas of the body. The current prevalent comfort back-supporting technology for the furniture and transportation market focuses on the lumbar (lower) region of the back to provide relief from fatigue. With the change from a primarily labor intensive work force to one of computer-using desk workers, we see an increase in low back pain. This is driving the need for an improvement in the location of the seating support system designed to prevent fatigue and the resultant discomfort. By transferring support from solely located in the lumbar region to now include the thoracic region of the spine, load is transferred to a more rigid section of the spinal column as well and a decrease in lower back pain should result.

A seating system for office or home seating furniture or vehicular seating systems, such as in automotive, train, off-road vehicular or aircraft seating, provides supporting pressure along the thoracic region of the user's spine between the T1 to the T12 vertebrae, and lesser support in the lumbar region. The region above the T1 vertebrae is the cervical region; and the regions below the T12 vertebrae are the lumbar, sacral and coccyx regions.

The support structure is to be positioned along the thoracic region of a seat back when the user is seated. The support structure can be used in a variety of seating systems. Some seating systems and components are shown by way of example and are described below.

There are four main factors that affect subjective posture: 1) smoothness of the pressure integral; 2) sufficiency of the pressure change; 3) ability to create even pressure for a wide range of anthropometry; and 4) ergonomic/control suitability of actuation.

A thoracic region seating system design is focused on addressing subjective posture factors. By supporting the thoracic region, the user's load is transferred from the lumbar region to the thoracic region, reducing stress and fatigue in the muscles, tendons, and vertebrae.

A design feature permits even pressure for a wide range of anthropometry, which can be accommodated by having the degree of pressure adjustable.

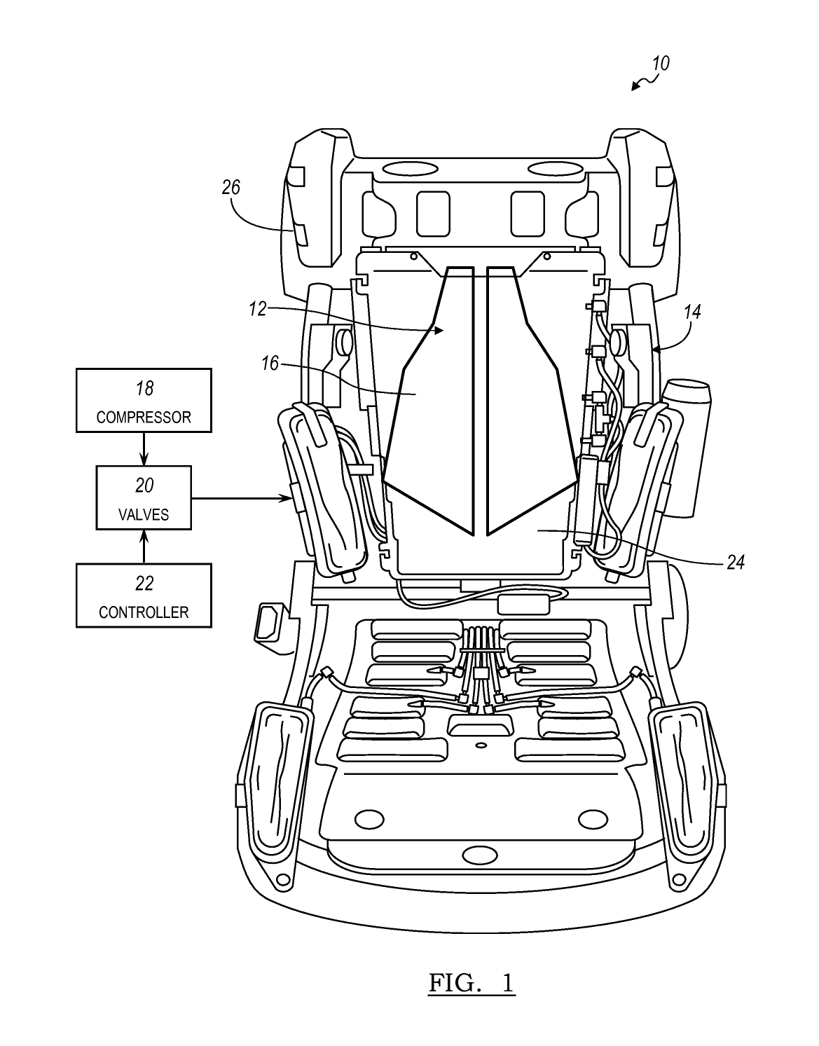

Referring now to FIG. 1, a seat assembly is illustrated partially disassembled to reveal underlying components and is referenced generally by numeral 10. The seat assembly 10 may be a vehicle seat such as for an automobile or an aircraft, an office chair, or any seat assembly that can benefit by an adjustable posture system. The seat assembly 10 is illustrated with an array of bladders that can be each adjustable and individually or collectively inflated providing support and stimulation at various locations in the seat intended to accommodate different sized and statured individual occupants, as a thoracic support system, which is referenced generally by numeral 12.

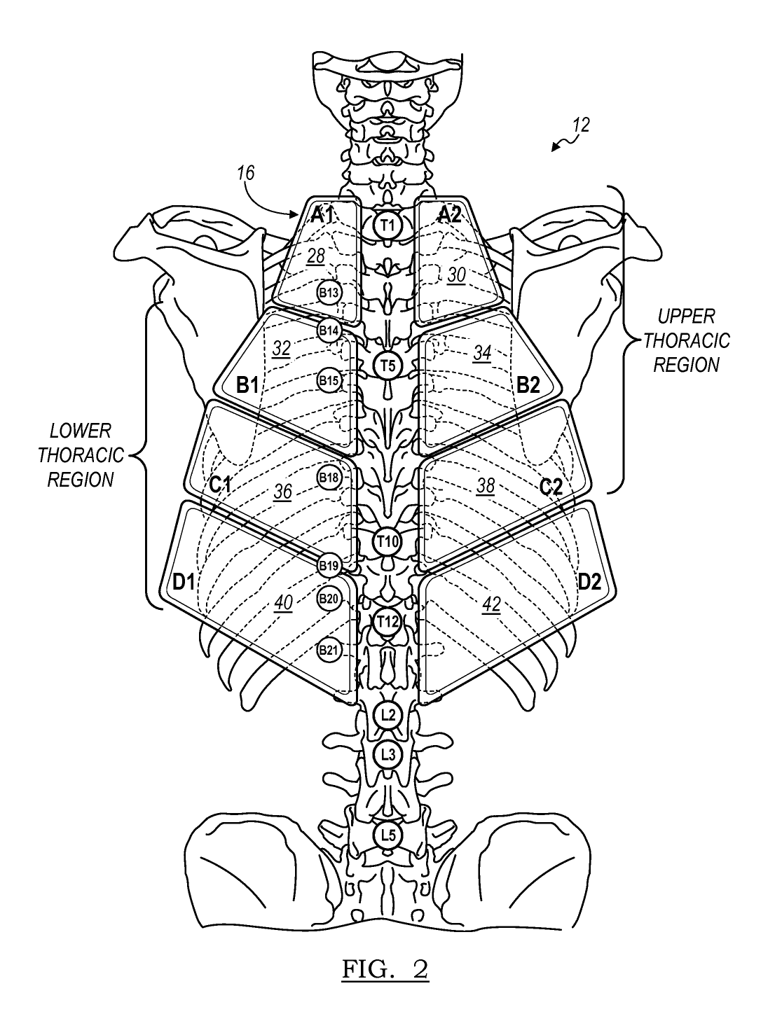

According to one embodiment, the thoracic support system 12 is a power pneumatic system in a seat back 14 which provides support and stimulation to thoracic vertebrae (FIG. 2) and a posterior rib cage (FIG. 2) between the shoulder blades (FIG. 2) to support an occupant to achieve a proper neutral seating posture. The thoracic support system 12 also utilizes pneumatic bag acupressure in the thoracic area of the seat back 14 to stimulate specific pressure points along both sides of the spine to deactivate trigger points which create positive muscle response.

The system supports are separated, and specifically shaped and positioned to stimulate areas along both sides of the thoracic spine. The supports are also inflated and deflated in a specific pattern to create a myofascial release effect to improve wellness and to assist thoracic support by stimulation.

The support system is provided with a plurality of support zones labeled A-D in FIG. 2. The support zones A, B, C, D are individually adjustable to achieve optimum support and stimulation conditions for a variety of postures and occupant sizes.

The support system 12 includes an air bladder assembly 16 (FIG. 2) that provides the zones A, B, C, D. The support system 12 includes a compressor 18 for providing a source of pressurized air to valves 20. The valves 20 are controlled by a controller 22. The valves 20 are in fluid communication with the zones A, B, C, D for controlling pressure and inflation of the zones A, B, C, D. Likewise, the valves 20 may exhaust the zones A, B, C, D for deflation of the zones. The controller 22 may operate as described in Lear U.S. patent application Ser. No. 14/560,436 filed on Dec. 4, 2014, which is incorporated in its entirety be reference herein. The controller 22 permits individual adjustment of pressure of each of the zones A, B, C, D as specified by an occupant selection or a predetermined pressure setting or program.

The air bladder assembly 16 is mounted to a suspension 24, such as a wire mat, that is connected to a frame 26 of the seat back 14 as illustrated in FIG. 1. The air bladder assembly 16 is oriented in a thoracic region of an occupant's back. In other words, the air bladder assembly 16 is sized to be located between the shoulder blades and between the T1 and T12 vertebrae for an average occupant as depicted in FIG. 2. The air bladder assembly 16 is provided with a plurality of support and stimulation regions 28, 30, 32, 34, 36, 38, 40, 42 within the seat back 14. The air bladder regions 28, 30, 32, 34, 36, 38, 40, 42 are arranged in pairs and oriented along an upright direction of the seat back 14 for each of the zones A-D. The air bladder regions 28, 30, 32, 34, 36, 38, 40, 42 are spaced apart laterally to provide a gap aligned with the spine. In order to distribute the air bladder assembly 16 into zones, the air bladder regions 28, 30, 32, 34, 36, 38, 40, 42 may be formed from various configurations, such as in irregular quadrilateral shapes, such as trapezoids.

Each of the first pair of air bladder regions 28, 30 is tapered outward towards the second pair of air bladder regions 32, 34 to fit between an occupant's shoulder blades with a lower end that is inclined laterally outboard. The second pair of air bladder regions 32, 34 are inclined laterally outward at both top and bottom edges, and is tapered further outboard to support the thoracic region of the occupant. Likewise, each of the third pair of air bladder regions 36, 38 and each of the fourth pair of air bladder regions 40, 42, are inclined laterally outward at top and bottom edges with increasing outward tapers to provide the zones C, D that fit adequately within the thoracic region.

The air bladder assembly 16 may be employed for thoracic acupressure myofascial release. The power pneumatic/electric system of the controller 22, compressor 18, valves 20 and air bladder assembly 16 in the seat back 14 may utilize pneumatic bladder acupressure in the thoracic area of the seat back 14 to stimulate specific pressure points along both sides of the spine to deactivate trigger points which create positive muscle response. The air bladder system support regions 28, 30, 32, 34, 36, 38, 40, 42 are separated, and specifically shaped and positioned to stimulate areas along both sides of the thoracic spine. The air bladder regions 28, 30, 32, 34, 36, 38, 40, 42 are also inflated and deflated in specific patterns to create a myofascial release effect to improve wellness and to assist thoracic support and stimulation.

An upper thoracic region is labeled in FIG. 2, which includes zones A-C provided by air bladder regions 28, 30, 32, 34, 36, 38. Dual-sided thoracic upper back support air bladder regions 28, 30, 32, 34, 36, 38 are operated to stimulate muscles along each side of the spine in the T3-T6 region. These areas are traditionally associated with acupressure points B13-B15 which are related with the cardiovascular and respiratory systems. The air bladder regions 28, 30, 32, 34, 36, 38 can be inflated/deflated individually on the right side and left side, or can be inflated/deflated simultaneously. The inflation/deflation sequence can be arranged in multiple patterns as programmed in the controller 22.

A lower thoracic region is also labeled in FIG. 2. Dual sided thoracic middle back air bladder support regions 32, 34, 36, 38, 40, 42 in zones B-D stimulate muscles along each side of the spine in the T7-T12 region. These areas are traditionally associated with acupressure points B18-B21 which are related with the digestive system. The air bladder regions 32, 34, 36, 38, 40, 42 can be inflated/deflated individually on the right side and left side, or can be inflated/deflated simultaneously. The inflation/deflation sequence can be arranged in multiple patterns as programmed in the controller 22.

One such pattern includes concurrently inflating the air bladder regions 28, 30, 32, 34, 36, 38 of the upper thoracic region. Then, the air bladder regions 28, 30, 32, 34, 36, 38 of the upper thoracic region are concurrently deflated. Next, the air bladder regions 32, 34, 36, 38, 40, 42 of the lower thoracic region are concurrently inflated. Then, the air bladder regions 32, 34, 36, 38, 40, 42 of the lower thoracic region are concurrently deflated. This pattern may then be repeated. This pattern may be alternated between right and left sides according to another embodiment.

Another pattern includes concurrently inflating the air bladder regions 28, 30, 32, 34, 36, 38 of the upper thoracic region. Then, the first pair of air bladder regions 28, 30 is concurrently deflated. Next, the fourth pair of air bladder regions 40, 42 is concurrently inflated. Then, the air bladder regions 40, 42 of the lower thoracic region are concurrently deflated. Then the first pair of air bladder regions 28, 30 is inflated. This pattern may then be repeated at the step of deflation of the first pair of air bladder regions 28, 30. This pattern may be alternated between right and left sides according to another embodiment.

Additionally, an array of air pressure sensors may be provided in the air bladder regions 28, 30, 32, 34, 36, 38, 40, 42 to measure air pressure readings that are conveyed to the controller 22. The controller 22 compares air pressure measurements from the left side 28, 32, 36, 40 with the corresponding measurements from the right side 30, 34, 38, 42 to determine if the occupant is seated evenly, for example if three or four of the comparisons are similar. If three comparisons are similar, and one is dissimilar, the controller 22 can determine that the occupant is seated evenly, yet the dissimilar pressure is a result of a tightened muscle within the air bladder region in the dissimilar zone with the greater pressure reading. In response, the associated air bladder region is inflated and deflated to vary pressure in the associated air bladder region to reduce tightness in the affected muscle.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An air bladder assembly for a seat comprising at least one pair of lateral air bladder regions spaced apart laterally wherein the at least one pair of lateral air bladder regions are each inclined laterally outboard to stimulate a thoracic region of a seat occupant.

2. The air bladder assembly of claim 1 wherein each of the at least one pair of lateral air bladder regions has a support surface defined by an irregular quadrilateral shape.

3. The air bladder assembly of claim 2 wherein the irregular quadrilateral shape is further defined as a trapezoid.

4. The air bladder assembly of claim 1 wherein the at least one pair of lateral air bladder regions is further defined as a first pair of lateral air bladder regions; and
wherein the air bladder assembly further comprises a second pair of lateral air bladder regions spaced apart laterally, wherein the second pair of lateral air bladder regions are each inclined laterally outboard to stimulate the thoracic region of the seat occupant, wherein the second pair of lateral air bladder regions are oriented adjacent to the first pair of lateral air bladder regions along an incline direction, and wherein the second pair of lateral air bladder regions have a lateral width that is less than that of the first pair of lateral air bladder regions.

5. The air bladder assembly of claim 4 wherein the air bladder assembly further comprises a third pair of lateral air bladder regions spaced apart laterally, wherein the third pair of lateral air bladder regions are each inclined laterally outboard to stimulate the thoracic region of the seat occupant, wherein the third pair of lateral air bladder regions are oriented adjacent to the second pair of lateral air bladder regions along an incline direction, and wherein the third pair of lateral air bladder regions have a lateral width that is less than that of the second pair of lateral air bladder regions.

6. The air bladder assembly of claim 5 wherein the air bladder assembly further comprises a fourth pair of lateral air bladder regions spaced apart laterally to stimulate the thoracic region of the seat occupant, wherein the fourth pair of lateral air bladder regions are oriented adjacent to the third pair of lateral air bladder regions along an incline direction, and wherein the fourth pair of lateral air bladder regions have a lateral width that is less than that of the third pair of lateral air bladder regions.

7. A seat assembly comprising:
a seat back; and
an air bladder assembly according to claim 1 oriented within a thoracic region of the seat back.

8. A method for adjusting a seat assembly comprising steps of:
operating an inflation device to inflate a first air bladder assembly oriented in a thoracic region of a seat back of a seat assembly; and
operating the inflation device to inflate a second air bladder assembly that is oriented in the thoracic region of the seat back, spaced laterally apart from the first air bladder assembly, after initiating inflation of the first air bladder assembly.

9. A computer-program product embodied in a non-transitory computer readable medium that is programmed for automatically adjusting a seat assembly, the computer-program product comprising instructions for performing the method of claim 8.

10. A seat assembly comprising:
a seat back;
a first air bladder assembly oriented in a thoracic region of the seat back;
a second air bladder assembly oriented in the thoracic region of the seat back, spaced apart from the first air bladder assembly;
an inflation device in fluid communication with the first and second inflatable air bladder assemblies; and
a controller in electrical communication with the inflation device and configured to perform the method of claim 8.

11. The seat assembly of claim 10 further comprising a deflation device in fluid communication with the first and second air bladder assemblies, and in electrical communication with the controller; and
wherein the controller is further configured to:
operate the deflation device to deflate the first air bladder assembly, and
operate the deflation device to deflate the second air bladder assembly after initiating deflation of the first air bladder assembly.

12. The seat assembly of claim 10 further comprising:
a third air bladder assembly spaced laterally apart from the first air bladder assembly;
a fourth air bladder assembly spaced laterally apart from the second air bladder assembly;
a deflation device in fluid communication with the first, second, third and fourth air bladder assemblies, and in electrical communication with the controller; and
an array of sensor assemblies, each provided in cooperation with one of the first, second, third and fourth air bladder assemblies and in electrical communication with the controller;
wherein the controller is further configured to:
determine from a comparison of input indicative of pressure data from the array of sensor assemblies that an occupant is seated evenly, and that the occupant has a tight muscle region, and
operate the inflation device and the deflation device to vary the pressure to the air bladder assembly associated with the identified tight muscle region.

13. A method for adjusting a seat assembly comprising steps of:
operating an inflation device to inflate a first air bladder assembly oriented in a thoracic region of a seat back of a seat assembly;
operating the inflation device to inflate a second air bladder assembly that is oriented in the thoracic region of the seat back, spaced apart from the first air bladder assembly in an upright direction of the seat back, after initiating inflation of the first air bladder assembly; and
operating the inflation device to inflate a third air bladder assembly that is oriented in the thoracic region of the seat back in between the first and second air bladder assemblies, concurrently with the inflation of the first air bladder assembly.

14. A computer-program product embodied in a non-transitory computer readable medium that is programmed for automatically adjusting a seat assembly, the computer-program product comprising instructions for performing the method of claim 13.

15. A seat assembly comprising:
a seat back;
a first air bladder assembly oriented in a thoracic region of the seat back;
a second air bladder assembly oriented in the thoracic region of the seat back, spaced apart from the first air bladder assembly;
a third air bladder assembly oriented in a thoracic region of the seat back in between the first air bladder assembly and the second air bladder assembly;
an inflation device in fluid communication with the first, second and third inflatable air bladder assemblies; and
a controller in electrical communication with the inflation device and configured to perform the method of claim 13.

16. The seat assembly of claim 15 further comprising a deflation device in fluid communication with the first and second air bladder assemblies, and in electrical communication with the controller; and
wherein the controller is further configured to operate the deflation device to deflate the second air bladder assembly and the third air bladder assembly before operating the inflation device to concurrently inflate the second air bladder assembly and the third air bladder assembly.

17. The seat assembly of claim 15 wherein the controller is further configured to operate the inflation device to inflate the third air bladder assembly concurrently with the inflation of the second air bladder assembly.

18. The seat assembly of claim 15 wherein the controller is further configured to operate the inflation device to inflate the second air bladder assembly subsequently after the inflation of the first and third air bladder assemblies.

19. The seat assembly of claim 18 further comprising a deflation device in fluid communication with the first, second and third air bladder assemblies, and in electrical communication with the controller; and
wherein the controller is further configured to operate the deflation device to deflate the first air bladder assembly and the third air bladder assembly before operating the inflation device to concurrently inflate the second air bladder assembly and the third air bladder assembly.

20. The seat assembly of claim 19 wherein the controller is further configured to:
operate the deflation device to deflate the second air bladder assembly and the third air bladder assembly; and
operate the inflation device to concurrently inflate the first air bladder assembly and the third air bladder assembly after the deflation of the second air bladder assembly and the third air bladder assembly.
